(19) United States
(12) Patent Application Publication
(10) Pub. No.: US 2020/0184848 A1
(43) Pub. Date: Jun. 11, 2020

(54) Teaching Aid for Tying a Shoe

(71) Applicant: Emily McCue, Red Bank, NJ (US)

(72) Inventor: Emily McCue, Red Bank, NJ (US)

(21) Appl. No.: 16/707,396

(22) Filed: Dec. 9, 2019

Related U.S. Application Data
(60) Provisional application No. 62/776,648, filed on Dec. 7, 2018.

(51) Int. Cl. G09B 19/00; A43C 9/00

(52) U.S. Cl. CPC G09B 19/0076; A43C 9/00

(57) ABSTRACT

The present invention provides a shoelace as an aid for teaching an individual to tie a shoe. The shoelace comprises labels at segments along its length which indicate points of the shoelace which are manipulated during the tying of a bowknot. The invention further comprises methods of tying the shoelace and instructing an individual to tie the shoelace.

### RELATED APPLICATION

This application claims the benefit of U.S. Provisional Application No. 62/776,648, filed on Dec. 7, 2018. The entire teachings of the above application are incorporated herein by reference.

### BACKGROUND OF THE INVENTION

Teaching aids are often used to help children and developmentally disabled adults develop skills of daily life. Such aids are designed to foster independence and promote self-confidence, and can focus on a variety of areas, including personal hygiene, dressing and household tasks. There is an ongoing need for improved teaching aids which simplify complex activities and more efficiently teach essential skills. Tying a shoe is a task that is often difficult to master. In particular, tying a shoe such that the shoe is adequately secured on the foot, provides a comfortable fit and does not easily become untied is a significant challenge to many people. There is thus a need for improved teaching aids to help people learn this essential skill.

### SUMMARY OF THE INVENTION

The present invention provides an improved device for teaching an individual to tie a shoe. The device consists of a shoelace which is labeled at certain points along its length and which facilitates mastery of the task of tying a shoelace in a conventional shoelace knot, also referred to as a bowknot, to secure a shoe on a foot. Preferably, the labels are at positions of the shoelace which are manipulated in the tying of a bowknot. More preferably, the labels are at positions of the shoelace which are manipulated in the tying of a bowknot on top of an individual's foot when the shoelace is substantially centered under the individual's foot. The shoelace optionally has one or more additional labels which aid in positioning the shoelace under the foot. For example, the shoelace can have an additional label at about the center of the shoelace as a guide for proper positioning of the shoelace under the foot.

The shoelace comprises labels at specific points along its length. For example, specific segments of the shoelace can be labeled by color, different textures or graphic labels to differentiate these segments from other parts of the shoelace. Preferably, these segments are labeled with a color, i.e., each labeled segment is designated by a color that distinguishes it from adjacent segments of the shoelace. Each labeled segment is separated from the next labeled segment by an intervening unlabeled segment.

In a first embodiment, the shoelace comprises five labeled segments. The first labeled segment is at one end of the shoelace and each succeeding labeled segment is between the first labeled segment and the second end of the shoelace.

The invention further provides methods of using the shoelace of the invention to teach an individual to tie a shoelace.

### BRIEF SUMMARY OF THE DRAWINGS

FIG. 1 is a schematic illustration of an embodiment of the shoelace of the invention having a length of about 36 inches. The elements in this figure are not drawn to scale.

FIG. 2 is a schematic illustration of an embodiment of the shoelace of the invention having a length of about 42 inches. The elements in this figure are not drawn to scale.

### DETAILED DESCRIPTION OF THE INVENTION

The present invention provides a shoelace for teaching an individual to tie a shoe. In a first embodiment, the shoelace has at least five labeled segments. In a preferred embodiment, the shoelace has exactly five labeled segments or exactly six labeled segments.

Each labeled segment is differentiated from the adjacent segment or segments of the shoelace. The labeled segments can be differentiated by any method that can be observed visually or by touch. In certain embodiments, the labeled segments are differentiated by texture. For example, the labeled segments can have a smooth texture while the unlabeled segments of the shoelace have a rough texture. In other embodiments, the labeled segments have a rough texture and the unlabeled segments of the shoelace have a smooth texture. The labeled segments can also be labeled with a graphic symbol, such as a letter or collection of letters, a number or a picture.

Preferably, the labeled segments of the shoelace are labeled by color, that is, each segment is a different color than the unlabeled segments of the shoelace.

In a preferred embodiment, the labeled segments of the shoelace are further differentiated from the non-labeled segments of the shoelace by their degree of stiffness or flexibility. For example, in certain embodiments, the labeled segments are preferably stiffer than the nonlabeled segments of the shoelace. The stiffness of the labeled segments can be increased using a variety of methods, such as, but not limited to, incorporation of a stiff material such as wire, for example ribbon wire, into the segment; coating the segment with a waterbase sealer, such as glue or a decoupage sealer, such as Mod Podge™; a fabric starch; or paint. Preferably, the segments are stiffened with paint. The greater stiffness of the labeled segments relative to the unlabeled segments provides several advantages. These advantages include (a) further differentiating the shoelace segments which are to be manipulated; (b) increasing the ability of the shoelace to maintain its shape during manipulation, facilitating the tying of the shoelace; and (c) providing tactile feedback to the user, increasing multisensory learning.

In one embodiment, the labelled segments are each painted a color other than white and the remaining portions of the shoelace are unpainted and preferably white.

The shoelace can be of any suitable length, and is preferably at least about 30 inches in length and more preferably at least about 34 inches in length. Preferably the shoelace is from 30 to 60 inches in length. More preferably, the shoelace is about 36 inches in length, about 42 inches in length or about 54 inches in length. Most preferably, the shoelace is about 36 inches in length or about 42 inches in length.

The shoelace can have a flat or round cross section. Preferably, the shoelace has a flat cross section.

The shoelace can be made of any suitable material, such as leather, cotton or another natural or synthetic fiber. In certain embodiments, the shoelace is made of cotton, textured polyester, spun polyester, nylon, or polypropylene.

The shoelace optionally has an aglet at one or both ends. Preferably, the shoelace has an aglet at both ends. The aglet is preferably made of a stiff material, such as a hard plastic.

In a preferred embodiment, the shoelace has a first labeled segment at one end. If there is an aglet at this end, the labeled segment preferably includes the aglet. The remaining labeled segments are between the first labeled segments and the other end of the shoelace, with each pair of labeled segments separated by an unlabeled segment of the shoelace.

In one embodiment, the labeled segments are from about 0.5 inch to about 1.5 inch long. In certain embodiments, each labeled segment is from 0.75 to 1.25 inches long. In one embodiment, each labeled segment is about 1 inch long. In other embodiments, the labelled segments are about 0.5 to about 2.5 inches long, or about 1 to about 2 inches long. In certain embodiments, the labels are about 1 inch or about 2 inches long.

The total length of the labeled segments relative to the length of the shoelace will depend on the length of the shoelace. For example, in one embodiment, the shoelace is about 36 inches long, has five labeled segments, and the labeled segments represent about 7% to about 21% of the length of the shoelace. In this embodiment, the labeled segments preferably represent about 10% to about 18% of the length of the shoelace. More preferably, the labeled segments represent about 14% of the length of the shoelace.

In another embodiment, the shoelace is about 48 inches long and has five labeled segments, and the labeled segments represent about 5% to about 16% of the total length of the shoelace. In this embodiment, the labeled segments preferably represent about 7.5% to about 13% of the length of the shoelace. More preferably, the labeled segments represent about 11% of the length of the shoelace.

In another embodiment, the shoelace is about 54 inches long and has five labeled segments, and the labeled segments represent about 4% to about 15% of the total length of the shoelace. In this embodiment, the labeled segments preferably represent about 6.5% to about 12% of the length of the shoelace. More preferably, the labeled segments represent about 9.25% of the length of the shoelace.

In another embodiment, the shoelace is about 42 inches long and has five or six labeled segments, and the labeled segments represent about 5% to about 16% of the total length of the shoelace. In this embodiment, the labeled segments preferably represent about 7.5% to about 13% of the length of the shoelace. More preferably, the labeled segments represent about 11% of the length of the shoelace.

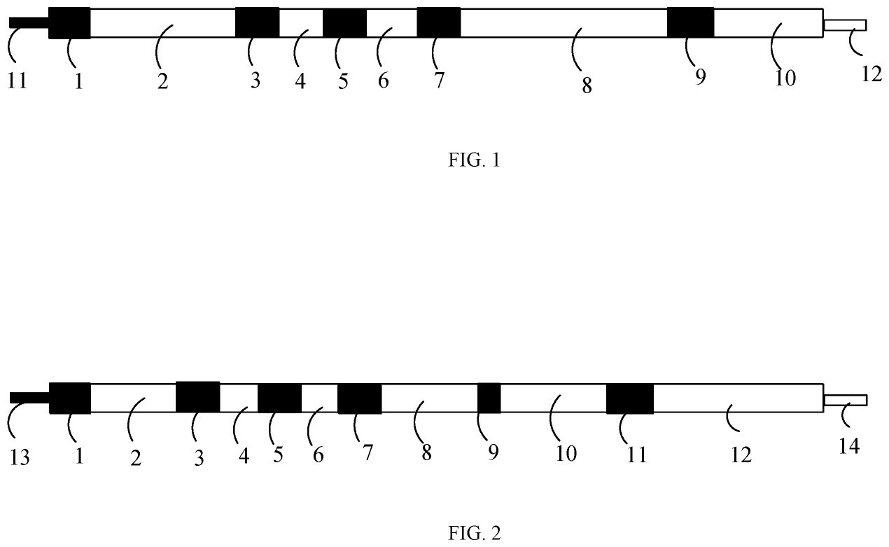

A preferred embodiment of a 36 inch (91.44 cm) shoelace of the invention is illustrated schematically in FIG. 1, which is not drawn to scale. Each labeled segment is labeled by color and is indicated in the figure in black. The first labeled segment (1) of length about 1 inch (about 2.54 cm) is at a first end of the shoelace, which in this illustration includes an optional aglet. Adjacent to the first labeled segment (1) is a first unlabeled segment (2) of the shoelace of length about 5.5 inches (about 13.97 cm). Following the first unlabeled segment (2) is a second labeled segment (3) of length about 1 inch (2.54 cm). Following the second labeled segment (3) is a second unlabeled segment (4) of length about 2.25 inches (5.72 cm). Following the second unlabeled segment (4) is a third labeled segment (5) of length about 1 inch (2.54 cm). Following the third labeled segment (5) is a third unlabeled segment (6) of length about 2.25 inches (5.72 cm). Following the third unlabeled segment (6) is a fourth labeled segment (7) of length about 1 inch (2.54 cm). Following the fourth labeled segment (7) is a fourth unlabeled segment (8) of length about 13.5 inches (34.29 cm). Following the fourth unlabeled segment (8) is a fifth labeled segment (9) of length about 1 inch (2.54 cm). The remainder of the shoelace (10) is unlabeled and has a length of about 7.5 inches (19.04 cm). The second end of the shoelace is illustrated with an optional aglet.

In a particularly preferred embodiment of the shoelace of FIG. 1, each labeled segment is about 1 inch long, and each labeled segment has a color which is different than the color of any other labeled segment. In another embodiment, two or more labeled segments are the same color. In certain embodiments, the first and third labeled segments are the same color and the remaining labeled segments are each a different color. In certain embodiments, the first and third labeled segments are each a first color, the second labeled segment is a second color, the fourth labeled segment is a third color and the fifth labeled segment is a fourth color, where preferably the first to fourth colors are not white and the unlabeled segments are white. For example, in one embodiment, the first labeled segment is red, the second labeled segment is yellow, the third labeled segment is red, the fourth labeled segment is green, the fifth labeled segment is blue and, preferably, the unlabeled segments are white. A preferred embodiment of a 42 inch shoelace of the invention is illustrated schematically in FIG. 2, which is not drawn to scale. Each labeled segment is labeled by color and is indicated in the drawing in black. The first labeled segment (1) of length about 2 inches (about 5.08 cm) is at a first end of the shoelace, which in this illustration includes an optional aglet (13). Adjacent to the first labeled segment is a first unlabeled segment (2) of length about 7.5 inches (about 19.05 cm). Following the first unlabeled segment (2) is a second labeled segment (3) of length about 2 inches (5.08 cm). Following the second labeled segment (3) is a second unlabeled segment (4) of length about 1 inch (2.54 cm). Following the second unlabeled segment (4) is a third labeled segment (5) of length about 2 inches (5.08 cm). Following the third labeled segment (5) is a third unlabeled segment (6) of length about 1 inch (2.54 cm). Following the third unlabeled segment (6) is a fourth labeled segment (7) of length about 2 inches (5.08 cm). Following the fourth labeled segment (7) is a fourth unlabeled segment (8) of length about 3 inches (7.62 cm). Following the fourth unlabeled segment (8) is a center labeled segment (9) of length about 1 inch (2.54 cm). Following the optional labeled segment (9) is a fifth unlabeled segment (10) of length about 6.5 inches (16.51 cm). Following the fifth unlabeled segment (10) is a fifth labeled segment (11) of length about 2 inches (5.08 cm). The remainder of the shoelace (12) is unlabeled and has a length of about 12 inches (30.48 cm). The second end of the shoelace is illustrated with an optional aglet (14). The center labeled segment (9) is optional. When present, the center labelled segment is useful as an aid for centering the foot on the shoelace. When the center labelled segment is absent, the fourth unlabeled segment, the center labeled segment and the fifth unlabeled segment, as shown in FIG. 2, can be replaced with a single unlabeled segment of length about 10.5 inches.

In one embodiment of the shoelace of FIG. 2, each labeled segment has a color which is different than the color of any other labeled segment. In another embodiment, two or more labeled segments are the same color. In certain embodiments, the first and third labeled segments are the same color and the remaining labeled segments are each a different color. In certain embodiments, the first and third labeled segments are each a first color, the second labeled segment is a second color, the fourth labeled segment is a third color and the fifth labeled segment is a fourth color, where preferably the first to fourth colors are not white and the unlabeled segments are white. In one embodiment, the first labeled segment is brown, the second labeled segment is yellow, the third labeled segment is red, the fourth labeled segment is green, the fifth labeled segment is blue and, if present, the center labeled segment is black. Preferably, the unlabeled segments are white.

One or more of the unlabeled segments of the shoelace of the invention can include markings or colors which differ from the labeling of the labeled segments. However, the unlabeled segments are preferably substantially free of markings. Preferably all of the unlabeled segments are of the same color, such as white.

The present invention further provides a method for teaching an individual to tie a shoe with a conventional bowknot. In one embodiment, the method is for teaching an individual to tie a shoelace of the invention having five labelled segments, such as the shoelace of FIG. 1. The method comprises instructing the individual to (a) place her foot on the fourth unlabeled segment, preferably with the foot substantially centered on the fourth unlabeled segment; (b) bring the ends of the shoelace together above the foot, keeping the second (unlabeled) end in front of the first (labeled) end; (c) bring the second end around and under the first end and pull on the ends to form a knot at top of the foot; (d) bring the second and fourth labeled segments together to form a first loop; (e) hold the fifth labeled segment and wrap the first end of the shoe lace around the base of the first loop to form a second loop; (f) pull the fifth labeled segment through the second loop to close the second loop and form a third loop; and (g) grasp the third and fifth labeled segments to pull the first and third loops apart, thereby forming and tightening the bow knot.

In another embodiment, the method is for teaching an individual to tie a shoelace of the invention having six labeled segments, such as the shoelace of FIG. 2. The method comprises the steps of instructing the individual to (a) place her foot on the center labeled segment; (b) bring the ends of the shoelace together above the foot, keeping the second end of the shoelace in front of the first end; (c) bring the second end around and under the first end and pull on the ends to form a knot at top of the foot; (d) bring the second and fourth labeled segments together to form a first loop; (e) hold the fifth labeled segment and wrap the first end of the shoelace around the base of the first loop to form a second loop; (f) pull the fifth labeled segment through the second loop to close the second loop and form a third loop; and (g) grasp the third and fifth labeled segments and pull the first and third loops apart, thereby forming and tightening the bowknot. The instruction of the individual can be assisted by use of a rhyme, verse or song that describes and/or reinforces the steps of tying the shoelace.

The subject can be any person having the need to learn how to tie a shoe. In certain embodiments, the individual is a child, for example, a child from about 5 years of age to about 10 or 12 years of age.

While this invention has been particularly shown and described with references to preferred embodiments thereof, it will be understood by those skilled in the art that various changes in form and details may be made therein without departing from the scope of the invention encompassed by the appended claims.

1-24. (canceled)

25. A shoelace comprising labels along its length at points which are manipulated by an individual in the tying of a bowknot when the shoelace is substantially centered under the individual's foot and the bowknot is tied on the upper surface of the foot.

26. The shoelace of claim 25, having at least five labels.

27. The shoelace of claim 25, wherein segments of the shoelace are labeled by color, different texture or graphic labels which differentiate said segments from the other parts of the shoelace.

28. The shoelace of claim 27, wherein the labeled segments are labeled by color, wherein each labeled segment has a color which distinguishes it from adjacent segments of the shoelace.

29. The shoelace of claim 28, wherein each labeled segment is separated from the next labeled segment by an intervening unlabeled segment.

30. The shoelace of claim 29, having five labeled segments.

31. The shoelace of claim 29, having a first labeled segment at one end of the shoelace and wherein each succeeding labeled segment is disposed between the first labeled segment and the second end of the shoelace.

32. The shoelace of claim 31, having 5 or 6 labeled segments.

33. The shoelace of claim 26, having an additional label substantially at the center of the shoelace.

34. The shoelace of claim 25, wherein the labeled segments have greater stiffness than the unlabeled segments of the shoelace.

35. The shoelace of claim 34, wherein the stiffness of the labeled segments is increased by at least one of (a) incorporation of a stiff material into the labeled segments;
or (b) coating the labeled segments with a waterbase sealer, a decoupage sealer, a fabric starch or paint.

36. The shoelace of claim 27, wherein each labeled segment is independently from about 0.5 inch to about 1.5 inch in length.

37. The shoelace of claim 27, wherein each labeled segment is independently from 0.75 to 2.5 inches long.

38. The shoelace of claim 25, wherein the shoelace is about 36 inches long, has five labeled segments, and the labeled segments represent about 7% to about 21% of the length of the shoelace.

39. The shoelace of claim 25, having a length of about 36 inches, said shoelace comprising:
(a) a first labeled segment (1) of length about 1 inch at a first end of the shoelace;
(b) a first unlabeled segment (2) of length about 5.5 inches adjacent to the first labeled segment;
(c) a second labeled segment (3) of length about 1 inch adjacent to the first unlabeled segment;
(d) a second unlabeled segment (4) of length about 2.25 inches adjacent to the second labeled segment;
(e) a third labeled segment (5) of length about 1 inch adjacent to the second unlabeled segment;
(f) a third unlabeled segment (6) of length about 2.25 inches adjacent to the third labeled segment;
(g) a fourth labeled segment (7) of length about 1 inch adjacent to the third unlabeled segment;
(h) a fourth unlabeled segment (8) of length about 13.5 inches adjacent to the fourth labeled segment;
(i) a fifth labeled segment (9) of length about 1 inch adjacent to the fourth unlabeled segment; and
(j) a fifth unlabeled segment (10) of length of about 7.5 inches and inclusive of the second end of the shoelace.

40. The shoelace of claim 25, having a length of about 42 inches, said shoelace comprising:
a) a first labeled segment (1) of length about 2 inches at a first end of the shoelace;
b) a second unlabeled segment (2) of length about 7.5 inches adjacent to the first labeled segment;
c) a second labeled segment (3) of length about 2 inches adjacent to the first unlabeled segment;
d) a second unlabeled segment (4) of length about 1 inch (2.54 cm) adjacent to the second labeled segment;
e) a third labeled segment (5) of length about 2 inches adjacent to the second unlabeled segment;
(f) a third unlabeled segment (6) of length about 1 inch adjacent to the third labeled segment;
g) a fourth labeled segment (7) of length about 2 inches adjacent to the third labeled segment;
h) a fourth unlabeled segment (8) of length about 3 inches adjacent to the fourth labeled segment;
i) a center labeled segment (9) of length about 1 inch adjacent to the fourth unlabeled segment;
j) a fifth unlabeled segment (10) of length about 6.5 inches adjacent to the center labeled segment;
k) a fifth labeled segment (11) of length about 2 inches adjacent to the fifth unlabeled segment; and
l) a sixth unlabeled segment of length about 12 inches and inclusive of the second end of the shoelace.

41. A method for teaching an individual to tie the shoelace of claim 39, with a bowknot, comprising instructing the individual to (a) place her foot on the fourth unlabeled segment, preferably with the foot substantially centered on the fourth unlabeled segment; (b) bring the ends of the shoelace together above the foot, keeping the second end of the shoelace in front of the first end; (c) bring the second end around and under the first end and pull on the ends to form a knot at top of the foot; (d) bring the second and fourth labeled segments together to form a first loop; (e) hold the fifth labeled segment and wrap the first end of the shoe lace around the base of the first loop to form a second loop; (f) pull the fifth labeled segment through the second loop to close the second loop and form a third loop; and (g) grasp the third and fifth labeled segments and pull the first and third loops apart, thereby forming and tightening the bowknot.

42. A method for tying the shoelace of claim 40, with a bowknot, comprising the steps of (a) placing a foot on the fourth unlabeled segment, preferably with the foot substantially centered on the fourth unlabeled segment; (b) bringing the ends of the shoelace together above the foot, keeping the second end of the shoelace in front of the first end; (c) bringing the second end around and under the first end and pull on the ends to form a knot at top of the foot; (d) bringing the second and fourth labeled segments together to form a first loop; (e) holding the fifth labeled segment and wrapping the first end of the shoe lace around the base of the first loop to form a second loop; (f) pulling the fifth labeled segment through the second loop to close the second loop and form a third loop; and (g) grasping the third and fifth labeled segments and pulling the first and third loops apart, thereby forming and tightening the bowknot.

43. A method for teaching an individual to tie the shoelace of claim 39, with a bowknot, comprising the steps of instructing the individual to (a) place her foot on the center labeled segment; (b) bring the ends of the shoelace together above the foot, keeping the second end of the shoelace in front of the first end; (c) bring the second end around and under the first end and pull on the ends to form a knot at top of the foot; (d) bring the second and fourth labeled segments together to form a first loop; (e) hold the fifth labeled segment and wrap the first end of the shoelace around the base of the first loop to form a second loop; (f) pull the fifth labeled segment through the second loop to close the second loop and form a third loop; and (g) grasp the third and fifth labeled segments and pulling the first and third loops apart, thereby forming and tightening the bowknot.

44. A method for tying the shoelace of claim 40, with a bowknot, comprising the steps of (a) placing a foot on the center labeled segment; (b) bringing the ends of the shoelace together above the foot, keeping the second end of the shoelace in front of the first end;
(c) bringing the second end around and under the first end and pulling on the ends to form a knot at top of the foot; (d) bringing the second and fourth labeled segments together to form a first loop; (e) holding the fifth labeled segment and wrapping the first end of the shoe lace around the base of the first loop to form a second loop; (f) pulling the fifth labeled segment through the second loop to close the second loop and form a third loop; and (g) grasping the third and fifth labeled segments and pulling the first and third loops apart, thereby forming and tightening the bowknot.
